(19) United States
(12) Patent Application Publication
(10) Pub. No.: US 2021/0209617 A1
(43) Pub. Date: Jul. 8, 2021

(54) AUTOMATED RECURSIVE DIVISIVE CLUSTERING

(71) Applicant: Ford Global Technologies, LLC, Dearborn, MI (US)

(72) Inventors: Chen Liang, Stamford, CT (US); Ye Liu, Union City, CA (US)

(73) Assignee: Ford Global Technologies, LLC, Dearborn, MI (US)

(21) Appl. No.: 16/735,446

(22) Filed: Jan. 6, 2020

(51) Int. Cl. G06Q 30/02; G06K 9/62; G06F 9/30; G06F 17/18

(52) U.S. Cl. CPC G06Q 30/0201; G06Q 30/0206; G06F 17/18; G06F 9/3005; G06K 9/6219

(57) ABSTRACT

Techniques for divisive clustering of a dataset to identify consumer choice patterns are described herein. The techniques include accessing a data source having a dataset to be analyzed and obtaining a feature list upon which the dataset is clustered. The dataset is hierarchically clustered using divisive clustering by estimating a conditional probability of stickiness for each feature of the feature list within the dataset. The feature having the greatest probability of stickiness is selected and used to split the dataset into clusters based on the feature. Then each cluster or branch of the dataset is recursively clustered using the same technique of estimating the probability of stickiness for each of the remaining features, selecting the feature with the highest probability of stickiness, and dividing the remaining dataset into clusters based on that feature. A nested logit model is generated using the hierarchical clustering and used to identify consumer choice patterns.

### BACKGROUND

R1 Determining consumer choice patterns can play a vital role in understanding consumer behavior when making purchase decisions. Understanding consumer choice patterns can help in identifying priorities the consumer considers when making decisions, which can help identify the product competitiveness and substitutions that may be made. Accordingly, consumer choice pattern recognition has become a principal instrument to direct market strategy and product planning.

### SUMMARY

Described herein are techniques for generating models to identify consumer choice pattern recognition. A nested logit model of the consumer choice behavior over a period of time is developed using a recursive divisive clustering technique described herein that clusters a dataset from the top down based on features that are selected for clustering the dataset. The recursive technique allows for clustering across the dataset such that each branch of the nested logit model may be clustered differently at different levels as described in detail below.

In some embodiments, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for generating a nested logit model depicting consumer choice patterns. The method may be performed by a server, such that the server accesses a data source including a dataset and obtains a list of features upon which the dataset is to be clustered. The server may hierarchically cluster the dataset by estimating a conditional probability of stickiness for each of the features based on the data in the dataset. The server may select the feature having the greatest probability of stickiness to form the first cluster of the dataset. The server may recursively cluster the remaining dataset based on each remaining feature and generate a nested logit model based on the hierarchical clustering. Other embodiments of this aspect include corresponding computer systems, apparatus, and computer programs recorded on one or more computer storage devices, each configured to perform the actions of the methods.

Implementations may include one or more of the following features. Optionally, recursively clustering the dataset based on the remaining features includes recursively clustering the dataset into branches based on the selected feature, removing the selected feature from the feature list, estimating the conditional probability of stickiness for each of the remaining features in each of the branches using the associated dataset for the branch, and selecting the next feature of the remaining features having the greatest probability of stickiness for the associated dataset for the branch.

Optionally, the dataset includes historical sales data. Optionally, the dataset includes historical vehicle sales data. Optionally, the server generates a market demand model based on the nested logit model. Optionally, the feature list includes brand of vehicle, segment of vehicle, power type of vehicle, and/or class of vehicle.

Optionally, the dataset is historical data for a first time period. The server may hierarchically cluster a second dataset using the feature list, where the second dataset is historical data for a second time period. The server may generate a second nested logit model based on the hierarchical clustering of the second dataset. The server may further identify a trend change between the first time period and the second time period based on the first nested logit model and the second nested logit model. Optionally, the server may generate a price and volume forecast based on the nested logit model. Implementations of the described techniques may include hardware, a method or process, or computer software on a computer-accessible medium.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a clustering system, according to some embodiments.

FIG. 2 illustrates a flow diagram, according to some embodiments.

FIG. 3 illustrates a nested logit structure, according to some embodiments.

FIG. 4 illustrates a method, according to some embodiments.

FIG. 5 illustrates a computer system, according to some embodiments.

FIG. 6 illustrates a cloud computing system, according to some embodiments.

### DETAILED DESCRIPTION

Identifying consumer choice patterns has become a principal instrument to direct market strategy and product planning. A nested logit model, which graphically characterizes the consumer choice processes, can represent the product substitution relationships. The substitution relationship can be multi-level, indicating the priorities in consumer's choice-making processes. In the auto-market, these levels can refer to vehicle features such as body type, fuel type, brand, and model. The nested logit structures can be leveraged by researchers and industrial organizations to build market demand models for demand forecast and for addressing demand variability.

In existing systems, consumer choice pattern has been determined based on clustering methods assisted by domain knowledge. Traditional clustering approaches include K-Means clustering, which is a partitional approach that groups variables to a predetermined number of clusters using a centroid-oriented cluster assignment, density-based spatial clustering of applications with noise (DBSCAN), which is a density-based approach that connects variables on a concentration basis, and hierarchical clustering, which is an agglomerative approach that clusters small groups of variables from the bottom up to a single cluster.

K-Means and DBSCAN have been widely adopted for signal and image processing. When applying for consumer choice pattern recognition, however, these approaches suffer from several limitations. For K-Means, the limitation is due to the number of clusters that needs to be predefined. This poses challenges to analysts who rely on the algorithm itself to identify the clustering pattern. Although there is no need to define clusters for DBSCAN, this method generates a few large clusters for most variables and treats the rest as noise. Such solutions cannot be used to generate insightful conclusions about the customer choices.

The most popular approach in identifying the consumer's choice pattern is the hierarchical clustering method. This method generates a dendrogram that represents the product similarity in a tree structure. Analysts have to identify the vehicle substitution relationship based on distances between each pair of vehicles. However, the hierarchical clustering method from the bottom up to a single cluster suffers from multiple drawings in identifying the consumer choice pattern. First, due to the bottom-up mechanism, it is extremely challenging to identify the consumers' priorities in making purchase decisions at early stages. For example, it can be observed that the neighboring vehicle models are strongly substitutive when consumers are making the final decision. However, it is unclear how consumers prioritize features such as vehicle segment, fuel type, and brand when they considered vehicle choices initially. Second, due to the lack of quantitative measurement of substitution across different features, this methodology also faces an obstacle in identifying the unique choice patterns for different types of consumers. Third, the resulting dendogram cannot explicitly capture the migration of the substitution pattern over time. For example, the emergence of electrified vehicles in recent years has resulted in the substitution with internal combustion engine vehicles that has slowly but steadily increased. The trend is important in determining future substitution relationships in support of electrified vehicle forecasts, however it is difficult to estimate using the dendogram produced by hierarchical clustering methods. Consequently, analysts can only identify the substitution pattern on in a heuristic manner, which introduces enormous judgment biases and human error.

To conquer these challenges, a quantitative metric needs to rank the features, organize them hierarchically into a tree structure, and explicitly display these metrics to evaluate the trend over time. The described probabilistic metric is based on the ‘feature stickiness’ to measure the degree of substitution. Further, a recursive tree algorithm is described that automatically produces a hierarchical structure that represents the heterogeneous substitution pattern.

One major advancement of the recursive divisive clustering techniques described herein is that the entire substitution hierarchy is generated automatically and exhaustively without human intervention. Further, it is not accurate to assume that across subsets of data the consumer groups will behave consistently. Accordingly, each subset of the dataset is independent analyzed at each step to identify, for that subset, the feature with the greatest conditional feature stickiness value (i.e., the measurement of feature stickiness for the remaining features contingent to that subset). As such, through the recursive process described, the consumer choice pattern will be automatically generated as a tree structure, and each branch of the tree will have its unique order of the features based on the probabilistic metric of feature stickiness.

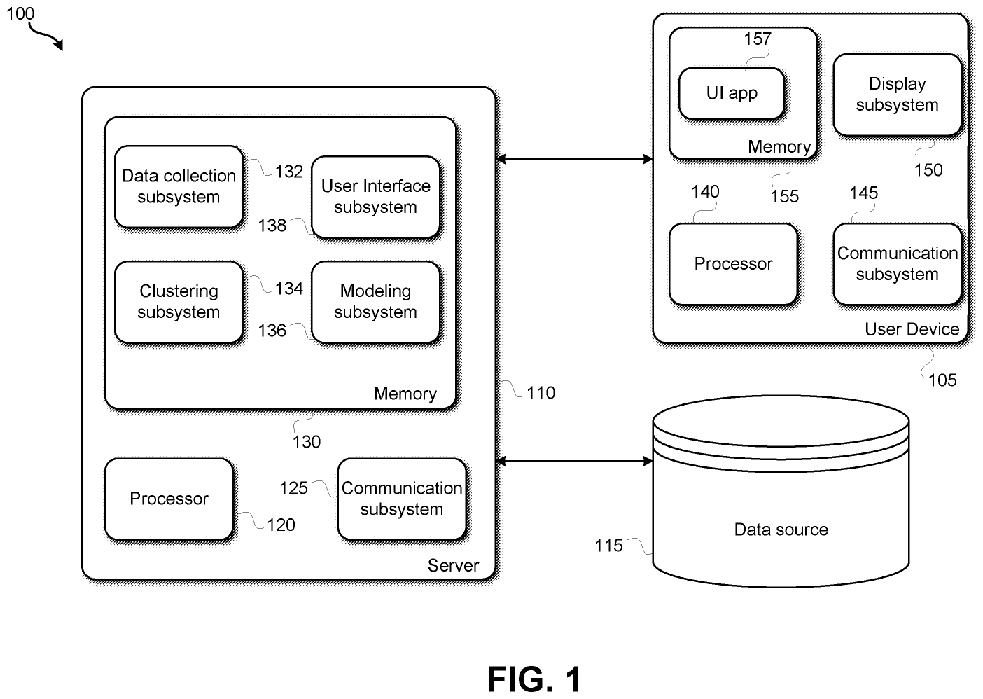

FIG. 1 illustrates a clustering system 100. The clustering system 100 includes a server 110, user device 105, and data source 115. The clustering system 100 may include more or fewer components and still perform the clustering as described herein.

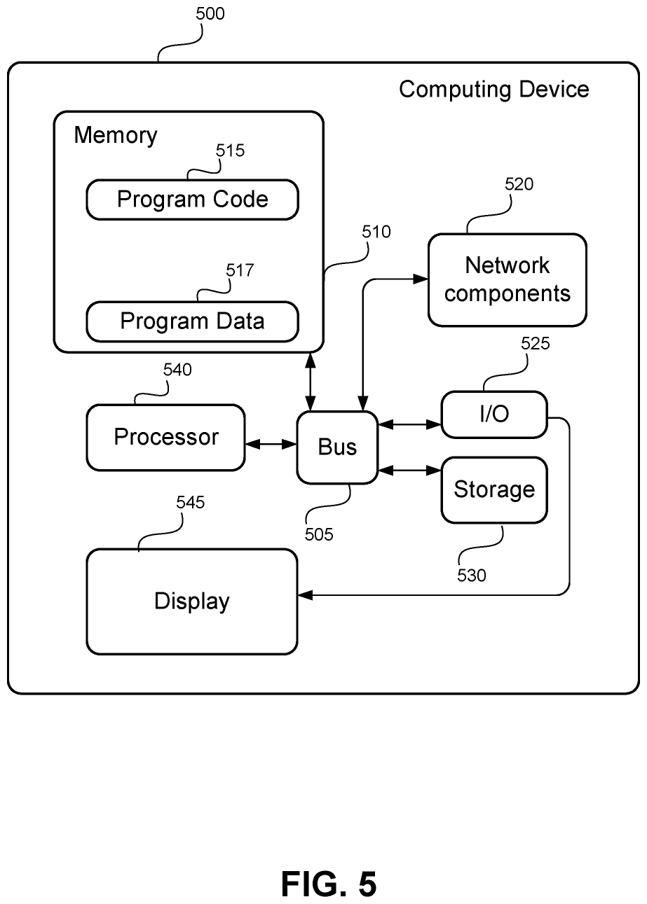

User device 105 includes processor 140, communication subsystem 145, display subsystem 150, and memory 155. User device 105 may be any computing device including, for example, a laptop computer, a desktop computer, a tablet, or the like, such as computing device 500 as described with respect to FIG. 5. While a single user device 105 is depicted, there may be more than one user device 105 in clustering system 100. User device 105 may include additional components than those depicted for ease of description. For example, user device 105 may include components described with respect to computing device 500 of FIG. 5, such as for example, I/O 525 and bus 505. Processor 140 may execute instructions stored in memory 155 to perform the functionality described. Memory 155 may include user interface (UI) application 157. UI application 157 may provide a graphical user interface for displaying the clusters and models generated by server 110 that are provided by user interface subsystem 138 through communication subsystems 125 and 145 to the UI application 157. Display subsystem 150 may include a display screen that is used to view the graphical user interface that may be generated for display by UI application 157 for viewing the models and clusters generated by server 110.

Data source 115 may be any suitable storage device including, for example, a database. Data source 115 includes at least one dataset that can be clustered by server 110. The dataset may be historical sales data, for example. More specifically, the dataset may be historical vehicle sales data, as another example. The dataset includes entries that include various features that may be used to cluster the dataset. Data source 115 may include a feature list of the features that may be used to cluster the dataset. As an example, the dataset may include entries for vehicle sales that includes details of the vehicle purchased as well as details of any vehicle being replaced or already owned by the purchaser. For example, the new vehicle purchase information may include the make, model, brand, fuel type (e.g., hybrid electric vehicle, fully electric vehicle, internal combustion engine), vehicle class (e.g., luxury or non-luxury), vehicle body type (e.g., truck, compact, sport utility vehicle, etc.), vehicle segment, and the like. The same information for the vehicle being replaced and/or already owned by the purchaser may be stored in association with the sales data. The feature list may include features for clustering including, for example, make, model, power type, vehicle class, vehicle type, and vehicle segment. While vehicle sales are used as examples throughout this description, the recursive divisive clustering techniques described herein are applicable to any clustering problem in which a dataset is to be clustered based on features. The described recursive divisive clustering is useful in particular to finding consumer choice patterns in historical sales data. An example of a dataset may be a new vehicle customer survey.

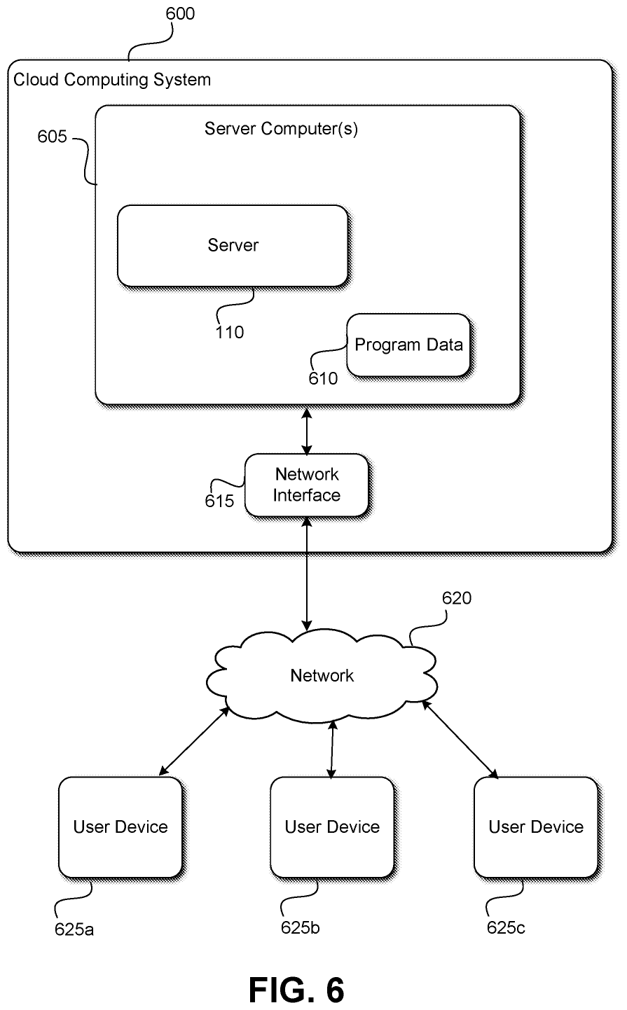

Server 110 may be any server having components for performing the recursive divisive clustering such as, for example, computing device 500. While a single server 110 is depicted, there may be more than one server 110 such as, for example in a distributed computing environment or a server farm. Server 110 may be in a cloud computing environment such as that depicted in FIG. 6. Server 110 includes a processor 120, communication subsystem 125, and memory 130. Server 110 may include additional components, such as those depicted in computing device 500, which are not shown in server 110 for ease of description. The processor 120 may execute instructions stored in memory 130 to perform the described functionality herein. Communication subsystem 125 may send and receive information to and from, for example, communication subsystem 145 of user device 105 or data source 115 using any suitable communication protocol.

Memory 130 includes data collection subsystem 132, clustering subsystem 134, and modeling subsystem 136, and user interface subsystem 138. While specific modules are described for simplicity of description and ease of the reader's understanding, the functionality described may be provided in more or fewer modules within memory 130 and server 110 without departing from the scope of the description.

Data collection subsystem 132 accesses data source 115 to obtain the dataset that is to be clustered. In some embodiments, data collection subsystem 132 obtains the feature list from the data source 115. In some embodiments, the data collection subsystem 132 may obtain the feature list from a user that provides the feature list via a graphical user interface provided by, for example, user interface subsystem 138. In some embodiments, the user may identify, using the graphical user interface, the dataset in data source 115. Data collection subsystem 132 may provide the dataset and feature list to clustering subsystem 134.

Clustering subsystem 134 may hierarchically cluster the dataset using the feature list using recursive divisive clustering. The clustering subsystem 134 identifies the feature stickiness, which measures the consumers' loyalty to a particular feature. This is the probability that the feature of the vehicle purchased is the same as the feature of the vehicle that is replaced. For example, if 80 out of 100 customers disposed of a small utility vehicle and purchased another small utility vehicle, then the segment feature has a feature stickiness of 0.8. As the stickiness value for the feature increases it indicates the customers' unwillingness to shift on that feature. Such unwillingness indicates weaker substitution within the subsets of this feature. Additionally, as the dataset is divided, the conditional feature stickiness measures the stickiness of the remaining features within the divided subset of the dataset. For example, if 65% of the utility consumers that disposed of a Ford® purchased another Ford®, the stickiness to the brand feature conditioned on utility, a subset of body type, is 0.65.

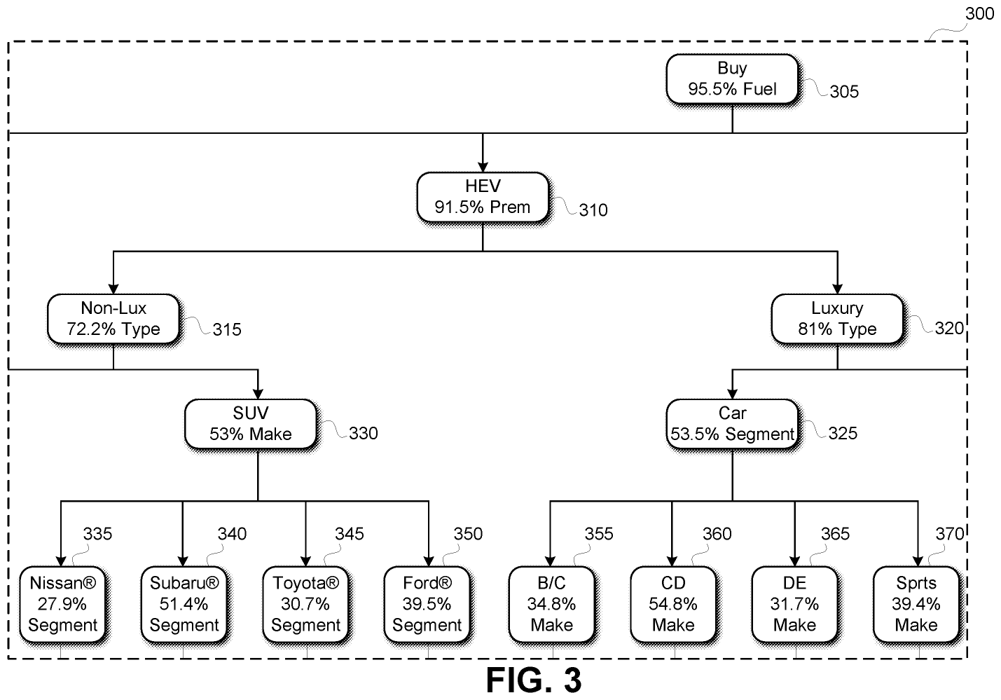

Clustering subsystem 134, to hierarchically cluster the dataset using the feature list and recursive divisive clustering, begins by estimating a feature stickiness for the dataset for each feature in the feature list. Clustering subsystem 134 selects the feature with the greatest feature stickiness value and splits the dataset based on the subset of the feature. Using the example portion of the nested logit model 300 shown in FIG. 3, the first feature selected as shown in element 310 is the fuel type such that the dataset was split so that all entries in the dataset that purchased a hybrid electric vehicle are clustered into element 310. The remaining entries in the dataset are divided into clusters based on their fuel type (e.g., internal combustion engine, diesel engine, fully electric vehicle, and so forth). For the purposes of the portion of the nested logit model 300 depicted in FIG. 3, only the cluster related to the purchasers of hybrid electric vehicles is shown. As shown by element 305, the feature stickiness value for fuel type is 0.045, which is the highest value across all features that were estimated.

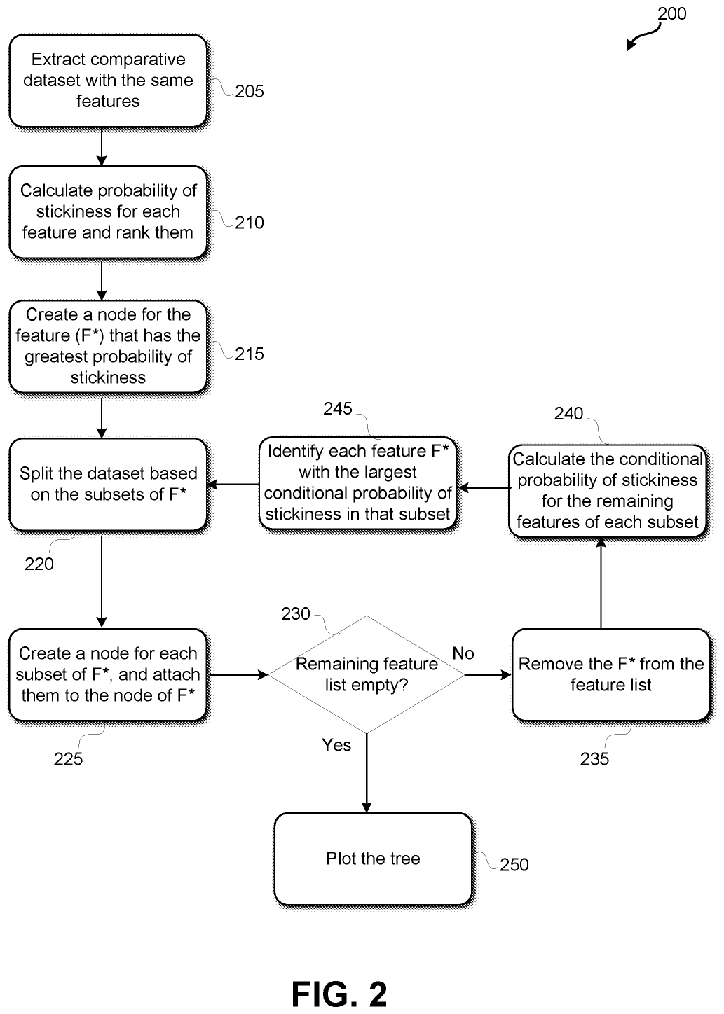

Clustering subsystem 134, having created the first level of clustered subsets of the dataset, recursively proceeds down each branch (i.e., each clustered subset) to generate the subsets for each branch. As such for each subset, the first selected feature is removed from the feature list and the conditional feature stickiness value is calculated for each remaining feature in the feature list for the subset of data. The conditional feature stickiness value having the highest value is selected, and the subset of data is split again into clusters. Returning to FIG. 3, the subset of data entries for customers purchasing a hybrid electric vehicle, as shown at element 310, is split by the vehicle class feature. As shown in element 310, the vehicle class feature has a conditional stickiness value of 0.085, so the subset of data is further split into two subsets as shown at element 315 having the non-luxury customers and at element 320 having the luxury customers. The process is recursively repeated through each branch until the dataset has been split at each branch by each feature. The recursive tree algorithm used by clustering subsystem 134 is shown and described in more detail with respect to FIG. 2.

Note in the nested logit model 300, each branch may be split differently than others at the same level. For example, the subset of data clustered at element 330 is split by vehicle make as shown by elements 335, 340, 345, and 350. However, at the same level of the neighboring branch shown by the subset of data clustered at element 325 is split by vehicle segment as shown by elements 355, 360, 365, and 370. The output of clustering subsystem 134 may be a clustered dataset in textual format. Clustering subsystem 134 may provide the textual format of the clustered dataset to the modeling subsystem 136.

Modeling subsystem 136 may analyze the textual format of the clustered dataset to generate, for example a nested logit model which can be easier for a user to view and understand visually. The example nested logit model 300 is a portion of an example nested logit model that may be output by modeling subsystem 136. Modeling subsystem 136 may use any visual depiction to display the hierarchical clustering created by clustering subsystem 134. For example, the user may have the option to select a visualization of the data. Modeling subsystem 136 may provide the visualization to the user interface subsystem 138.

User interface subsystem 138 may generate the graphical user interface for the user to view the visualization created by modeling subsystem 136. Additionally, user interface subsystem 138 may provide a graphical user interface for the user to make selections to, for example, the list of features, the dataset, the preferred visualization, and the like. The user interface subsystem 138 may provide the graphical user interface on a display of the server 110 (not shown) or by providing the graphical user interface to the UI application 157 on user device 105 for display in display subsystem 150.

FIG. 2 illustrates a flow chart of the recursive tree algorithm 200 used by clustering subsystem 134. While the flowchart depicts the algorithm in a specific manner, some or all of the steps described may be performed in a different order or in parallel. In some embodiments, steps performed on each branch may be performed in parallel on differing branches of the dataset. The recursive tree algorithm 200 may be performed, for example, by processor 120 executing the instructions in clustering subsystem 134 of server 110.

Recursive tree algorithm 200 begins at step 205 by extracting the comparative dataset with the same features. As an example, a new vehicle customer survey may provide the details and features of the new vehicle in addition to the details and features of the vehicle that was replaced. The dataset, therefore, has comparative features of both the disposed of and new vehicles for calculating the feature stickiness value (i.e., the probability that the consumer purchased a new vehicle with the same feature as the old vehicle) for each feature of interest. The features of interest (i.e., the feature list) are also collected for use in clustering the dataset.

At step 210, clustering subsystem 134 calculates the probability of stickiness for each feature and ranks the features. The probability of stickiness (i.e., the feature stickiness value) is calculated for each feature based on every data point in the dataset. For example, if the dataset contains information on 5,000 customer purchases (e.g., new vehicles) including information on the customers' disposed of item (e.g., disposed of vehicle), there will be 5,000 data points for calculating the feature stickiness value for each feature. The feature list may include any number of features (e.g., 10, 25, 50, 100, and so forth). As an example, perhaps there are 100 features, where the features may be any feature ranging from vehicle class (e.g., luxury vs. non-luxury) to details such as whether the vehicle contains heated seats or not.

At step 215, clustering subsystem 134 creates a node for the feature (F*) that has the greatest probability of stickiness (i.e., the greatest feature stickiness value). At step 220, the clustering subsystem splits the dataset based on the subsets of F*. For example, if F* is vehicle class, the dataset will be split into two subsets (i.e., luxury and non-luxury). As another example, if F* is vehicle fuel type, the dataset will be split into multiple subsets (i.e., hybrid electric vehicles, fully electric vehicles, diesel engines, ethanol fuel engines, and the like). Each subset will include the subset of data entries that qualify the data point into the subset based on the feature. For example, using the vehicle class example, all customers that purchased a luxury vehicle will be in the luxury subset, and each customer that purchased a non-luxury vehicle will be in the non-luxury subset.

At step 225, clustering subsystem 134 creates a node for each subset of F* and attaches them to the node of F*. As described above, for example two nodes are created for vehicle class (luxury and non-luxury), and the nodes are attached to the node above. The data subsets for each node are associated with the node.

At decision block 230, clustering subsystem 134 determines whether the remaining feature list is empty. If so, the clustering subsystem 134 plots the textual tree at step 250. The text-based tree can be provided to the modeling subsystem 136 for creation of a visualization such as a nested logit model (e.g., nested logit model 300). If there are remaining features in the feature list, the clustering subsystem 134 removes F* from the feature list at step 235.

At step 240, clustering subsystem 134 calculates the conditional probability of stickiness for the remaining features of each subset. For example, if there are two subsets (luxury and non-luxury), the conditional probability of stickiness (i.e., the conditional feature stickiness value) is calculated for each remaining feature in each subset. In this way, each branch is addressed.

At step 245, clustering subsystem 134 identifies each feature F* with the largest conditional feature stickiness value in that subset. Accordingly, continuing with the example, for the luxury subset, a feature F* is identified, and for the non-luxury subset a feature F* is identified. The feature F* may be different between the two subsets.

The clustering subsystem 134 returns to step 220 to split the dataset (subset) based on the subsets of F* for each subset. This is shown visually in the nested logit model 300 of FIG. 3. For example, element 315 is the non-luxury subset, and element 320 is the luxury subset. The feature F* for the non-luxury subset is vehicle type, and one of the subsets is seen at element 330 (i.e., sport utility vehicles). Similarly, the feature F* for the luxury subset is also vehicle type, and one of the subsets is seen at element 325 (i.e., car).

The clustering subsystem 134 continues to step 225 again and creates a node for each subset of F*, and attaches them to the node of F*. As shown in FIG. 3, a node for each of the subsets of vehicle types is created and attached to the parent node (i.e., element 330 is attached to element 315). Again, the clustering subsystem 134 determines if the feature list is empty at decision block 230. This continues recursively until each branch is completed. The nested logit model 300 depicts that the conditional feature stickiness value for the subset of customers that chose hybrid electric vehicles that were non-luxury sport utility vehicles then favored the feature of make of the vehicle most (at 53% based on the information in element 330). However, the customers that chose hybrid electric vehicles that were luxury cars favored the feature of segment most (at 53.5% based on the information in element 325).

FIG. 3 illustrates an example portion of a nested logit model 300. The nested logit model 300 has been described above with respect to the clustering subsystem 134 and recursive tree algorithm 200. The nested logit model 300 is an example of the visualization that may be provided by modeling subsystem 136. As shown in nested logit model, the first feature having the greatest stickiness value is fuel type (with 95.5% of customers sticking with the same fuel type as the favored feature to retain from all customers surveyed). Nodes are created for each fuel type, but hybrid electric vehicle at element 310 is the only shown for ease of description and space. Customers that chose hybrid electric vehicles then favored sticking with the vehicle class of luxury or non-luxury as the highest feature stickiness value at 91.5% of all remaining features. The branching and subsets continue down through the features of make and segment, and may continue beyond those features, which is not shown.

The nested logit model 300 may be used to identify which features are of importance to certain purchasers, which may help forecast price and model information, which may help drive decisions on pricing, inventory, and/or manufacturing. Further, multiple nested logit models may be generated based on executing a recursive divisive clustering algorithm such as recursive tree algorithm 200 on multiple datasets covering different time periods. For example, the new vehicle customer survey conducted for 2017, the new vehicle customer survey conducted for 2018, and the new vehicle customer survey conducted for 2019 will provide three separate datasets over differing time periods that may each be analyzed. Three nested logit models may be generated, and trend changes over time may be identified by comparing the nested logit models. In some embodiments, the comparison may be done automatically by server 110.

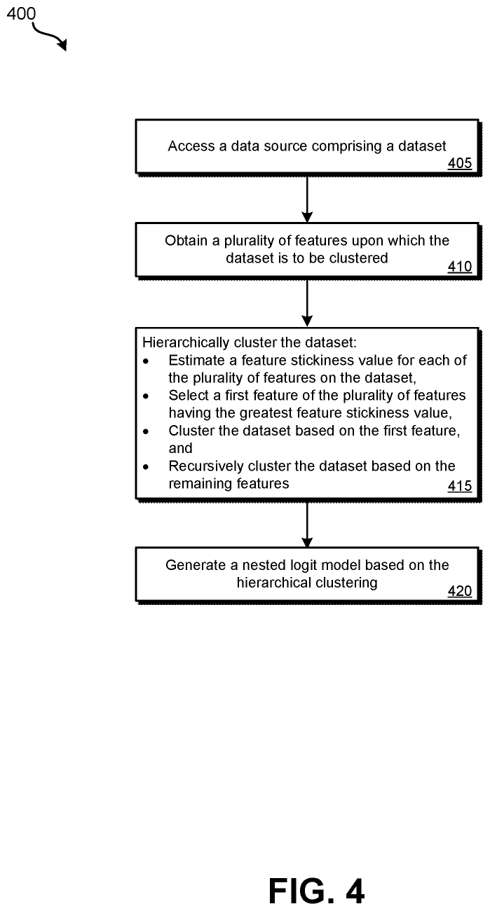

FIG. 4 illustrates a method 400 for identifying consumer choice patterns. Method 400 may be performed by server 110 of FIG. 1. The steps of FIG. 4 are depicted in a specific order, however the steps may be performed in differing order or in parallel in some embodiments. Method 400 begins at step 405 with the server 110 accessing a data source (e.g., data source 115) that includes a dataset (e.g., a new vehicle consumer survey dataset).

At step 410, server 110 obtains a plurality of features upon which the dataset is to be clustered. For example, the server 110 may obtain the features from the user via a graphical user interface. In some embodiments, the features may be obtained from the data source. In some embodiments, the list of features may be obtained from the data source or some other source and provided to the user via the graphical user interface for the user to select those features of interest to include in the feature list used to cluster the dataset.

At step 415, the server 110 may hierarchically cluster the dataset. The recursive tree algorithm 200 may be used to hierarchically cluster the dataset. The server 110 may estimate the conditional feature stickiness value for each of the plurality of features on the dataset. The conditional feature stickiness value for each feature, as described above, is the probability that the consumers in the dataset will purchase a new vehicle with the same feature that their disposed of vehicle has (e.g., replacing a luxury vehicle with another luxury vehicle). The server 110 may select the first feature that has the greatest feature stickiness value, and cluster (i.e., split) the dataset based on the first feature. In other words, if the vehicle class is selected, those that purchased a luxury vehicle are split into a subset and those that purchased a non-luxury vehicle are split into the second subset.

At step 420, the server 110 may generate a nested logit model based on the hierarchical clustering. For example, the portion of the nested logit model 300 depicted in FIG. 3 may be generated. Once generated, the nested logit model or other visual depiction may be provided to the user via a graphical user interface.

Examples of Computing Environments for Implementing Certain Embodiments

Any suitable computing system or group of computing systems can be used for performing the operations described herein. For example, FIG. 6 illustrates a cloud computing system 600 by which at least a portion of the functionality of server 110 may be offered. FIG. 5 depicts an example of a computing device 500 that may be at least a portion of user device 105 and/or server 110. The implementation of the computing device 500 could be used for one or more of the subsystems depicted in FIG. 1. In an embodiment, a single user device 105 or server 110 having devices similar to those depicted in FIG. 5 (e.g., a processor, a memory, etc.) combines the one or more operations and data stores depicted as separate subsystems in FIG. 1.

FIG. 5 illustrates a block diagram of an example of a computer system 500. Computer system 500 can be any of the described computers herein including, for example, server 110 or user device 105. The computing device 500 can be or include, for example, an integrated computer, a laptop computer, desktop computer, tablet, server, or other electronic device.

The computing device 500 can include a processor 540 interfaced with other hardware via a bus 505. A memory 510, which can include any suitable tangible (and non-transitory) computer readable medium, such as RAM, ROM, EEPROM, or the like, can embody program components (e.g., program code 515) that configure operation of the computing device 500. Memory 510 can store the program code 515, program data 517, or both. In some examples, the computing device 500 can include input/output (“I/O”) interface components 525 (e.g., for interfacing with a display 545, keyboard, mouse, and the like) and additional storage 530.

The computing device 500 executes program code 515 that configures the processor 540 to perform one or more of the operations described herein. Examples of the program code 515 include, in various embodiments, data collection subsystem 132, clustering subsystem 134, modeling subsystem 136, user interface subsystem 138, or any other suitable systems or subsystems that perform one or more operations described herein (e.g., one or more development systems for configuring an interactive user interface). The program code 515 may be resident in the memory 510 or any suitable computer-readable medium and may be executed by the processor 540 or any other suitable processor.

The computing device 500 may generate or receive program data 517 by virtue of executing the program code 515. For example, the dataset and subsets are all examples of program data 517 that may be used by the computing device 500 during execution of the program code 515.

The computing device 500 can include network components 520. Network components 520 can represent one or more of any components that facilitate a network connection. In some examples, the network components 520 can facilitate a wireless connection and include wireless interfaces such as IEEE 802.11, Bluetooth, or radio interfaces for accessing cellular telephone networks (e.g., a transceiver/antenna for accessing CDMA, GSM, UMTS, or other mobile communications network). In other examples, the network components 520 can be wired and can include interfaces such as Ethernet, USB, or IEEE 1394.

Although FIG. 5 depicts a single computing device 500 with a single processor 540, the system can include any number of computing devices 500 and any number of processors 540. For example, multiple computing devices 500 or multiple processors 540 can be distributed over a wired or wireless network (e.g., a Wide Area Network, Local Area Network, or the Internet). The multiple computing devices 500 or multiple processors 540 can perform any of the steps of the present disclosure individually or in coordination with one another.

In some embodiments, the functionality provided by the clustering system 100 may be offered as cloud services by a cloud service provider. For example, FIG. 6 depicts an example of a cloud computing system 600 offering a clustering service that can be used by a number of user subscribers using user devices 625a, 625b, and 625c across a data network 620. User devices 625a, 625b, and 625c could be examples of a user device 105 described above. In the example, the clustering service may be offered under a Software as a Service (SaaS) model. One or more users may subscribe to the clustering service, and the cloud computing system performs the processing to provide the clustering service to subscribers. The cloud computing system may include one or more remote server computers 605.

The remote server computers 605 include any suitable non-transitory computer-readable medium for storing program code (e.g., server 110) and program data 610, or both, which is used by the cloud computing system 600 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 605 can include volatile memory, non-volatile memory, or a combination thereof.

One or more of the servers 605 execute the program code 610 that configures one or more processors of the server computers 605 to perform one or more of the operations that provide clustering services, including the ability to utilize the clustering subsystem 134, modeling subsystem 136, and so forth, to perform clustering services. As depicted in the embodiment in FIG. 6, the one or more servers 605 provide the services to perform clustering services via the server 110. Any other suitable systems or subsystems that perform one or more operations described herein (e.g., one or more development systems for configuring an interactive user interface) can also be implemented by the cloud computing system 600.

In certain embodiments, the cloud computing system 600 may implement the services by executing program code and/or using program data 610, which may be resident in a memory device of the server computers 605 or any suitable computer-readable medium and may be executed by the processors of the server computers 605 or any other suitable processor.

In some embodiments, the program data 610 includes one or more datasets and models described herein. Examples of these datasets include new vehicle consumer datasets, etc. In some embodiments, one or more of data sets, models, and functions are stored in the same memory device. In additional or alternative embodiments, one or more of the programs, data sets, models, and functions described herein are stored in different memory devices accessible via the data network 615.

The cloud computing system 600 also includes a network interface device 615 that enable communications to and from cloud computing system 600. In certain embodiments, the network interface device 615 includes any device or group of devices suitable for establishing a wired or wireless data connection to the data networks 620. Non-limiting examples of the network interface device 615 include an Ethernet network adapter, a modem, and/or the like. The server 110 is able to communicate with the user devices 625a, 625b, and 625c via the data network 620 using the network interface device 615.

### GENERAL CONSIDERATIONS

While the present subject matter has been described in detail with respect to specific aspects thereof, it will be appreciated that those skilled in the art, upon attaining an understanding of the foregoing, may readily produce alterations to, variations of, and equivalents to such aspects. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Aspects of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

What is claimed is:

1. A method, comprising:
accessing a data source comprising a dataset;
obtaining a plurality of features upon which the dataset is to be clustered;
hierarchically clustering the dataset, the hierarchical clustering comprising:
estimating a feature stickiness value for each of the plurality of features on the dataset,
selecting a first feature of the plurality of features having the greatest feature stickiness value,
clustering the dataset based on the first feature, and
recursively clustering the dataset based on the remaining features; and
generating a nested logit model based on the hierarchical clustering.

2. The method of claim 1, wherein recursively clustering the dataset based on the remaining features comprises recursively:
clustering the dataset into a plurality of branches based on the first feature;
removing the first feature from the plurality of features;
estimating a conditional feature stickiness for each of the remaining features in each of the plurality of branches using the associated dataset for the branch; and
selecting the first feature of the remaining features having the greatest feature stickiness value for the associated dataset for the branch.

3. The method of claim 1, wherein the dataset comprises historical sales data.

4. The method of claim 1, further comprising:
generating a market demand model based on the nested logit model.

5. The method of claim 1, wherein the dataset comprises historical vehicle sales data.

6. The method of claim 5, wherein the plurality of features comprises at least one of a brand of vehicle, a segment of vehicle, a power type of vehicle, a body type of vehicle, or a class of vehicle.

7. The method of claim 1, wherein the dataset is historical data for a first time period, the method comprising:
hierarchically clustering a second dataset using the plurality of features, wherein the second dataset is historical data for a second time period;
generating a second nested logit model based on the hierarchical clustering of the second dataset; and
identifying a trend change between the first time period and the second time period based on the nested logit model and the second nested logit model.

8. The method of claim 1, further comprising:
generating a price and volume forecast based on the nested logit model.

9. A system, comprising:
one or more processors; and
a memory having stored thereon instructions that, when executed by the one or more processors, cause the one or more processors to:
access a data source comprising a dataset;
obtain a plurality of features upon which the dataset is to be clustered;
hierarchically cluster the dataset, the instructions for hierarchically clustering the dataset comprising instructions that, when executed by the one or more processors, cause the one or more processors to:
estimate a feature stickiness value for each of the plurality of features on the dataset,
select a first feature of the plurality of features having the greatest feature stickiness value,
cluster the dataset based on the first feature, and
recursively cluster the dataset based on the remaining features; and
generate a nested logit model based on the hierarchical clustering.

10. The system of claim 9, wherein the instructions to recursively cluster the dataset based on the remaining features comprises further instructions that, when executed by the one or more processors, cause the one or more processors to recursively:
cluster the dataset into a plurality of branches based on the first feature;
remove the first feature from the plurality of features;
estimate a conditional feature stickiness for each of the remaining features in each of the plurality of branches using the associated dataset for the branch; and
select the first feature of the remaining features having the greatest feature stickiness value for the associated dataset for the branch.

11. The system of claim 9, wherein the dataset comprises historical sales data.

12. The system of claim 9, wherein the instructions comprise further instructions that, when executed by the one or more processors, cause the one or more processors to:
generate a market demand model based on the nested logit model.

13. The system of claim 9, wherein the dataset comprises historical vehicle sales data.

14. The system of claim 13, wherein the plurality of features comprises at least one of a brand of vehicle, a segment of vehicle, a power type of vehicle, a body type of vehicle, or a class of vehicle.

15. The system of claim 9, wherein the dataset is historical data for a first time period, and wherein the instructions comprise further instructions that, when executed by the one or more processors, cause the one or more processors to:
hierarchically cluster a second dataset using the plurality of features, wherein the second dataset is historical data for a second time period;
generate a second nested logit model based on the hierarchical clustering of the second dataset; and
identify a trend change between the first time period and the second time period based on the nested logit model and the second nested logit model.

16. The system of claim 9, wherein the instructions comprise further instructions that, when executed by the one or more processors, cause the one or more processors to:
generate a price and volume forecast based on the nested logit model.

17. A non-transitory, computer-readable medium comprising instructions that, when executed by one or more processors, cause the one or more processors to:
access a data source comprising a dataset;
obtain a plurality of features upon which the dataset is to be clustered;
hierarchically cluster the dataset, the instructions for hierarchically clustering the dataset comprising instructions that, when executed by the one or more processors, cause the one or more processors to:
estimate a feature stickiness value for each of the plurality of features on the dataset,
select a first feature of the plurality of features having the greatest feature stickiness value,
cluster the dataset based on the first feature, and
recursively cluster the dataset based on the remaining features; and
generate a nested logit model based on the hierarchical clustering.

18. The non-transitory, computer-readable medium of claim 17, wherein the instructions to recursively cluster the dataset based on the remaining features comprises further instructions that, when executed by the one or more processors, cause the one or more processors to recursively:
cluster the dataset into a plurality of branches based on the first feature;
remove the first feature from the plurality of features;
estimate a conditional feature stickiness for each of the remaining features in each of the plurality of branches using the associated dataset for the branch; and
select the first feature of the remaining features having the greatest feature stickiness value for the associated dataset for the branch.

19. The non-transitory, computer-readable medium of claim 17, wherein the instructions comprise further instructions that, when executed by the one or more processors, cause the one or more processors to:
generate a market demand model based on the nested logit model.

20. The non-transitory, computer-readable medium of claim 17, wherein the dataset is historical data for a first time period, and wherein the instructions comprise further instructions that, when executed by the one or more processors, cause the one or more processors to:
hierarchically cluster a second dataset using the plurality of features, wherein the second dataset is historical data for a second time period;
generate a second nested logit model based on the hierarchical clustering of the second dataset; and
identify a trend change between the first time period and the second time period based on the nested logit model and the second nested logit model.
